(19) United States
(12) Patent Application Publication
(10) Pub. No.: US 2013/0339191 A1
(43) Pub. Date: Dec. 19, 2013

(54) Engine, System and Method of Providing a Second-Hand Marketplace

(71) Applicants: Jaclyn Shanfeld, Santa Monica, CA (US); Jenna Stahl, Santa Monica, CA (US)

(72) Inventors: Jaclyn Shanfeld, Santa Monica, CA (US); Jenna Stahl, Santa Monica, CA (US)

(73) Assignee: SHOP HERS, Santa Monica, CA (US)

(21) Appl. No.: 13/905,786

(22) Filed: May 30, 2013

Related U.S. Application Data
(60) Provisional application No. 61/653,054, filed on May 30, 2012.

(51) Int. Cl. G06Q 30/06

(52) U.S. Cl. CPC G06Q 30/0627
USPC 705/26.63

(57) ABSTRACT

The present invention provides a system for transacting the sale of second-hand items by, in part, using a matching engine for presenting a product to a user in accordance with at least one user attribute and at least one product attribute related to the at least one product, providing a transaction manager for accepting funds from the user in exchange for the at least one product, which funds may be stored in a trust account. User attributes may also be associated with a size gauge where at least one image of the user and the size gauge may be presented to the matching engine. The system may also present a product based on social media interaction between the user and the seller of the product.

### CROSS-REFERENCE TO RELATED APPLICATIONS

The present invention claims priority to U.S. Provisional Patent Application No. 61/653,054, titled Engine, System And Method Of Providing A Second-Hand Marketplace, filed May 30, 2012, and is incorporated herein by reference as if set forth in its entirety.

### FIELD OF THE INVENTION

The present invention relates to marketing and selling of second-hand goods using a socially interactive platform, and, more particularly, to an engine, system and method of providing a second-hand marketplace.

### BACKGROUND OF THE INVENTION

Traditional consignment shopping is done through the aggregation of used clothing and other accessory items into a storefront where potential buyers may come and browse selected items brought to the store by sellers. The store owner generally receives a very small fraction of an item's actual sale value in the decline in value has the sets and the nature of a consent store. Furthermore, the seller of the merchandise is generally reliant on the store owner to provide reimbursement for the sale of the merchandise reports that the seller provides to the store to self out an agreed price. Such reimbursement however may be very late in time in regards to the providing of the merchandise by the seller and or the actual sale of the merchandise by the store owner, or may just not happen at all. In such a situation, the seller of the merchandise does not have access and cannot audit the books and receipts of the store owner and made us never be able to verify whether or not the item was sold stolen or otherwise sold a great price. Furthermore, the store owner may reject items based on personal taste, size and may further removed from display any item based on his or her discretion Further, sales of merchandise within the storefront is generally limited to the local community in which the stores located and the foot traffic which may pastor were by the storefront. Thus the consignment store generally has a very small potential buying audience.

For the purchaser of such views products of a typical consignment shop is generally limited in its selection based on geographical area and the sellers available to provide merchandise. Similarly very high quality merchandise and foremost desirous selections within the consignment shop are generally purchased immediately bought a consignment shop regulars just leaving the less consistent buyers to choose from less desirable items. In general, consignment shops may be well disorganized and overcrowded with merchandise and they generally provide a less than optimal experience for the buyer.

Thus, there is a need for a system that allows for the efficient exchange of second-hand goods. More particularly, there is a need for an engine, system and method of providing a second-hand marketplace

### SUMMARY

The present invention provides an engine, system and method for providing a marketplace for second-hand goods wherein such goods may be matched to prospective buyers based on a variety of factors and buyer characteristics. Such characteristics may allow for a more targeted and precise shopping experience and may allow for more efficient and successful sales of second-hand items. The present invention may be immediately deployable within an existing technology infrastructure, and may be deployed as a thin client and/or user-transparent client, and may further provide for cross-platform communication between social networks and other ecommerce access points not otherwise communicatively compatible.

Thus, the present invention provides a marketplace for second-hand goods tailored to the user of the system. More particularly, there is a need for an engine, system and method to provide remote access to a rules-based marketplace for which sellers may offer for sale second-hand goods accessible to potential buyers in accordance with the rules and the characteristics of the user.

It is to be understood that both the foregoing general description and the following detailed description are exemplary and explanatory, and are intended to provide further explanation of the invention as discussed hereinthroughout.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and methods;

FIG. 3 illustrates an exemplary embodiment of the graphical user interface if the present invention;

FIGS. 4A, 4B, 5A, 5B and 5C illustrate an exemplary sizing gauges for use with the present invention;

FIG. 6 is a block diagram of an exemplary system for use in accordance with herein described systems and methods;

FIGS. 7A, 7B and 7C illustrates exemplary sizing categories for use with the present invention;

FIG. 8 is a block diagram of an exemplary escrow system for use in accordance with herein described systems and methods; and

FIGS. 9, 10A, 10B, 11 and 12 illustrate exemplary embodiments of a graphical user interface used with the present invention.

### DETAILED DESCRIPTION

A computer-implemented platform and methods of use are disclosed that provide networked access to a plurality of types of digital content, including but not limited to video, audio, and document content, and that track and deliver the accessed content, such as via one or more applications, or “apps.” Described embodiments are intended to be exemplary and not limiting. As such, it is contemplated that the herein described systems and methods can be adapted to provide many types of users with access and delivery of many types of domain data, and can be extended to provide enhancements and/or additions to the exemplary services described. The invention is intended to include all such extensions. Reference will now be made in detail to various exemplary and illustrative embodiments of the present invention.

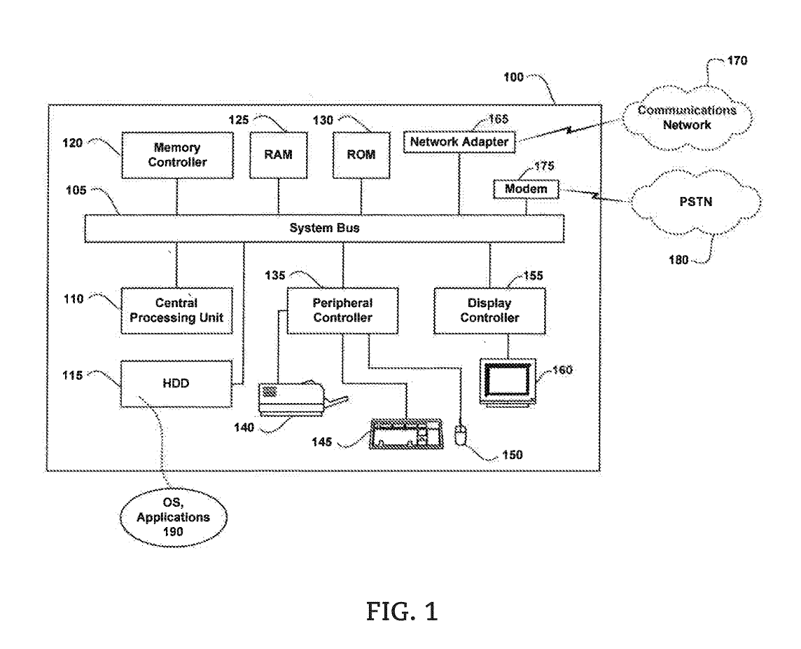

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

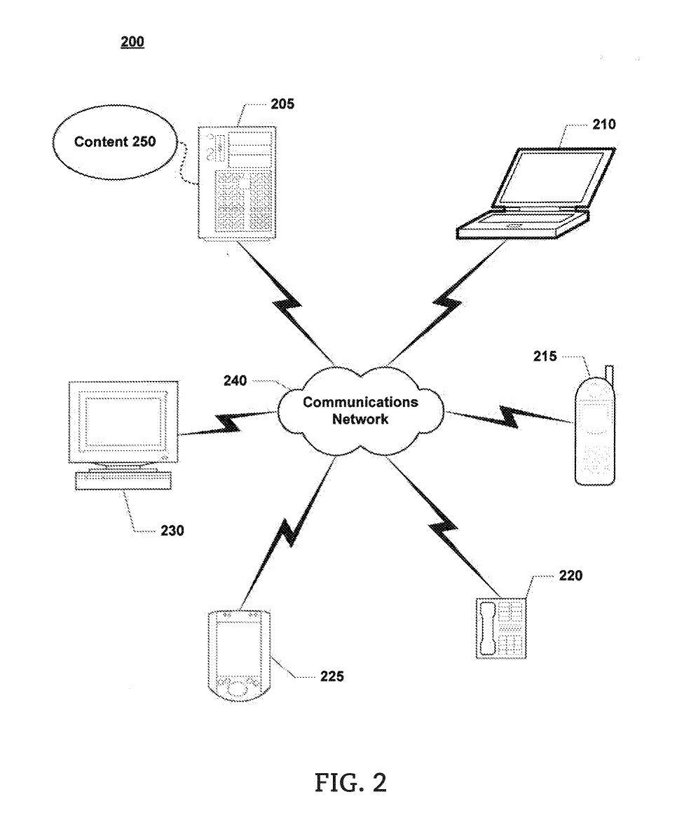

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile telephone, PDA, tablet or smart phone and may have any device compatible operating system. Such operating systems may include, for example, Symbian, RIM Blackberry OS, Android, Apple iOS, Windows Phone, Palm webOS, Maemo, bada, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Of course, because many of the aforementioned operating systems are proprietary, in prior art embodiments server 205 delivered to client device 225 only those applications and that content applicable to the operating system and platform communication relevant to that client device 225 type.

The present invention may provide a marketplace for the buying and selling of second-hand goods between any users of the system. Goods offered for sale may be both new and used and may include, for example, clothing, shoes, jewelry, bags, pocketbooks, coats, hats, socks, intimates, gloves, swim wear, spa wear, accessories, sunglasses and spectacles, perfumes, makeup, and related accessories. As used herein, the term “seller” refers to a system user who may be offering an item for sale, while the term “buyer” refers to a system user who may be interested in purchasing an offered item. A seller may typically own a relatively high volume of designer goods and may be interested in selling some items that have fallen out of style in the seller's circle, do not fit as the seller wants, or otherwise is no longer desired and/or used by the seller. Selling items may also allow a “fashion-forward” consumer to rollover his/her inventory of goods while allowing a buyer to obtain designer merchandise, generally at a reduced cost versus new.

A buyer may generally be looking to purchase goods to enhance a wardrobe and to purchase desired goods at a discounted price. Similarly, a buyer may obtain goods not otherwise available to them outside the present system. For example, a pair of Alexander McQueen shoes may be available only through outlets in specific metropolitan areas, such as New York City, and not otherwise easily obtainable by a buyer located in the mid-west United States. In this way, not only may the buyer have access to discounted priced designer shoes, but may have access to goods not otherwise available for purchase by other means.

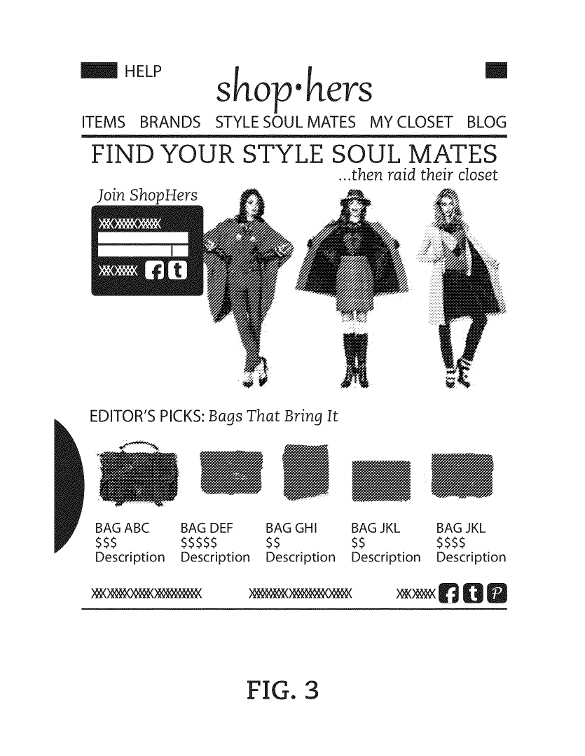

As illustrated in FIG. 3, the present invention may require account creation for any user of the system and may require a log in of that user for access to the system. As will be discussed in more detail herein, the graphical user interface (GUI) associated with the present invention my offer access to goods being sold, social interaction with other users, an account vault, such as a virtual closet, for example, and user preferences and characteristics. The GUI may also offer targeted offerings prior to and during login to the site either in accordance with user characteristics and/or the volume and type of offerings within the system.

In an embodiment of the present invention, goods are offered for sale in accordance with user characteristics. This may mean that attributes of both the seller and buyer may be used to position goods within the system. Attributes that may be collected from users of the system may include, but is not limited to, the user's physical measurements, interest in certain types of goods, interest in certain designers and/or brands, geographical proximity, favorite color, lifestyle preference, education, profession, social network connections, average purchasing price point, average selling price point, closet and/or wardrobe size, for example. Each of these attributes may further encompass a myriad of sub-attributes. For example, a user's interest in certain types of goods may include making known a preference for Fendi versus Burberry branded goods, dresses over skirts, boots over high heels, patterns over block, and items under $150 versus $3,000.

A user's physical measurements may be collected in two ways and may include, for example, a users' bust size (if applicable), waist size, hip size, inseam, shoe size, height, weight, ring size, neck size, and sleeve length. As would be appreciated by those skilled in the art, these measurements may be taken by a user and input into the present invention. However, to increase the accuracy of such measurement and to automate the process of providing such dimensional information, the present invention may allow for the automated collection of a user's dimensions.

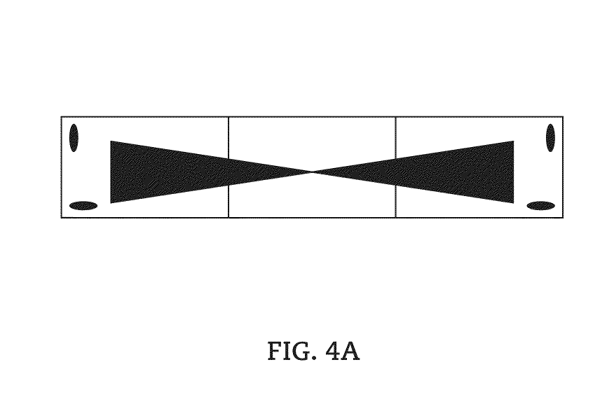

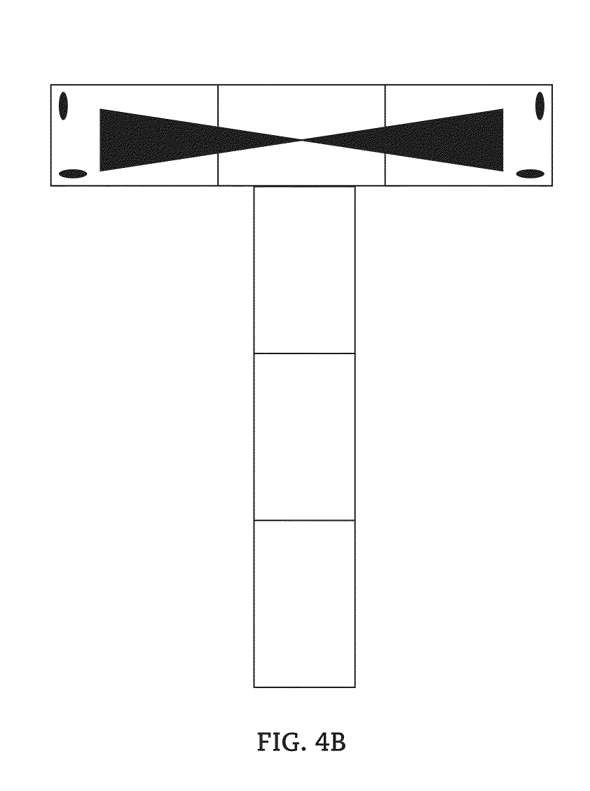

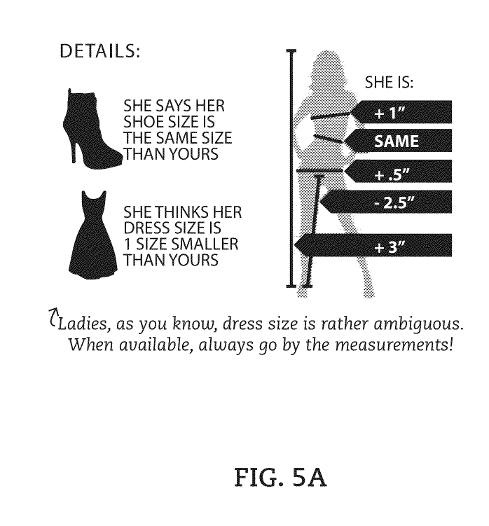

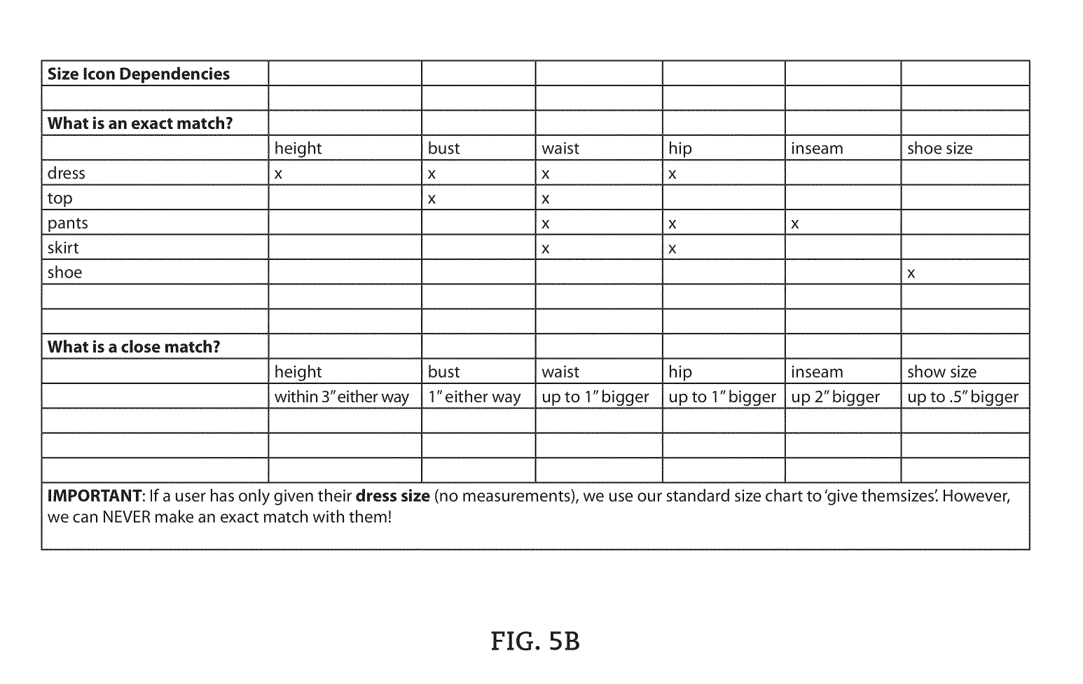

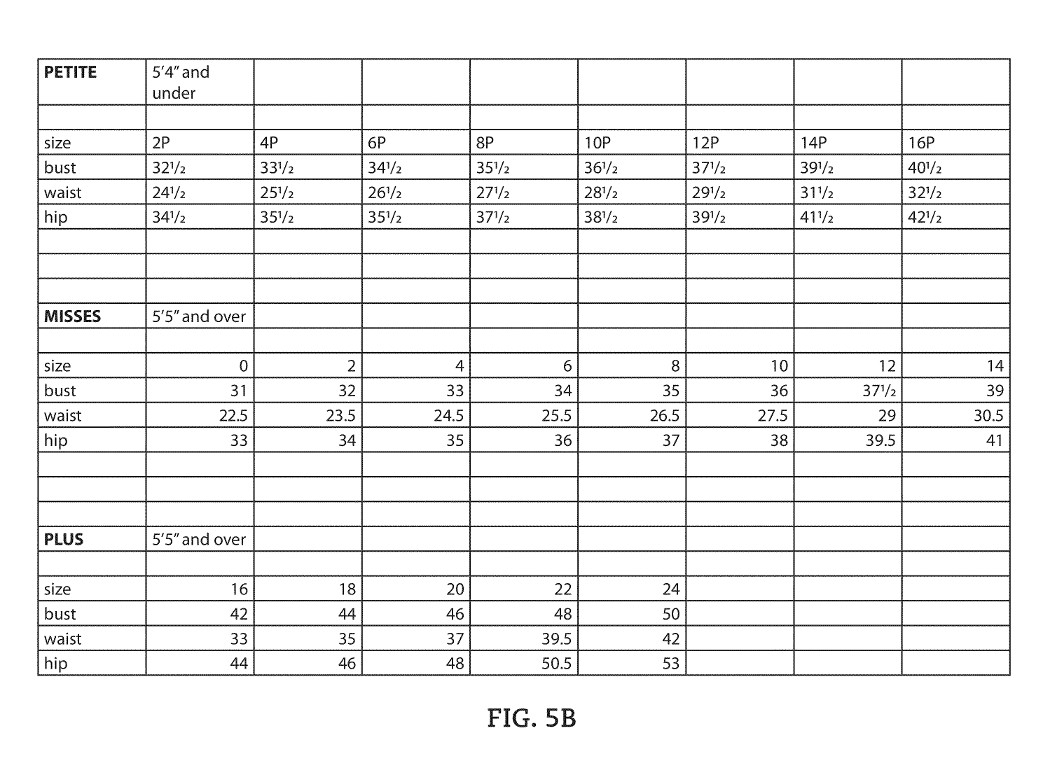

In an embodiment of the present invention, a user may print out a sizing gauge provided by the present invention and illustrated in FIGS. 4A and B. The sizing gauge may consist of at least two parts and may be further broken into parts as desired. The sizing gauge may be formed as a “T” utilizing a print out on standard 8.5×11 inch paper. For example, the present invention may provide for a print out consisting of seven (7) pages, four (4) of which may be hung lengthwise, end-to-end vertically rising from the floor with the remaining three (3) pages horizontally affixed lengthwise and centered above the lower four (4) pages. Generally, such a configuration is created along a continuous and accessible surface, such a bedroom wall.

Each of the pages of the sizing gauge may have markings and/or direction for use and may allow for a video and/or picture to be recorded and uploaded to the system to more accurately size the user. For example, the horizontal pages may include at least one shape of a known dimension which may be compared to the user. There may also be a variety of smaller various shapes included within the sizing gauge which may assist in the size calculation of the user and may allow for the angle of the lens which took the picture to be taken into account. As would be appreciated by those skilled in the optical arts, this may be done by comparing the known dimensions of the shapes to the actual dimensions measures in the provided picture.

For example, a user may print out a series of pages making up a size gauge and may affix those pages as instructed to a wall in the user's home. The user may don appropriate attire (such as thin, tight fitting clothes and/or the like) and may stand up straight with their back against the sizing gauge to take a first picture. If desired, the user may also take at least a profile picture to capture addition dimensions.

In an embodiment of the present invention, users may offer for sale at least one item to at least one other user and may, preferably, offer for sale at least one used good, such as designer clothing, to a user in accordance with at least one of the user's attributes. In this way, the present invention may allow for a more targeted offering of goods to those users who may best match the attributes of the goods. For example, a user may have an attribute which denotes the user's affinity towards goods produced under the brand name Marc Jacobs and may have provided to the system at least one sizing attribute, as discussed above. Thus, when searching within the present invention for a specific item, such as a skirt, for example, the user may be presented with at least one skirt produced under the Marc Jacobs label and within the size requirement of the user.

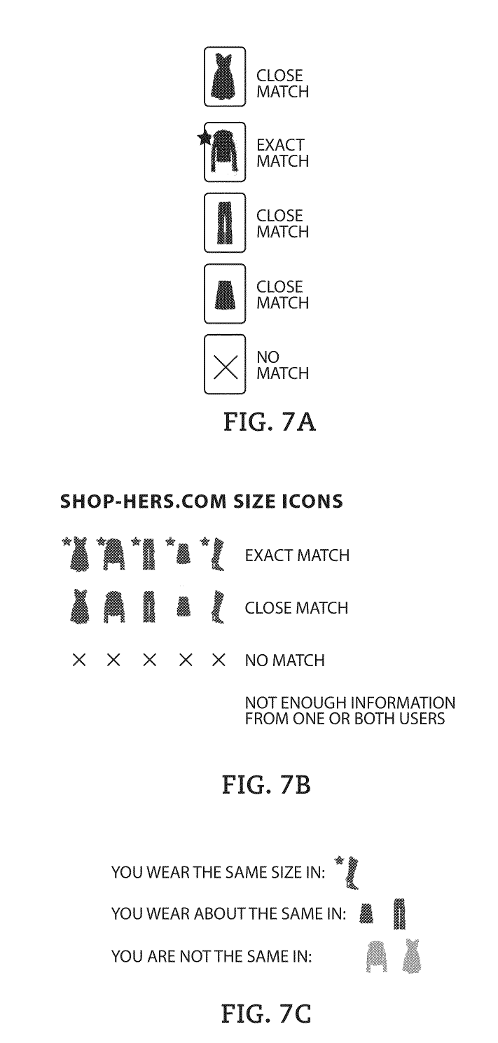

Similarly, a plurality of goods may be presented to the user under the same search and may include more than one designer and size of good. For example, the present invention may further show the user with available skirts made under designer of similar style and/or price point as Marc Jacobs and may further present skirts in a variety of sizes which may be suitable for the user. To assist in differentiating sizes, as illustrated in FIGS. 7A, B and C, which may vary by manufacturer, for example, the present invention may group like sizes into broader categories, such as, for example, “exact match” (which may mean a match to the user's known size), and/or a “close match” (which may mean within two (2) sizes to the user's known size).

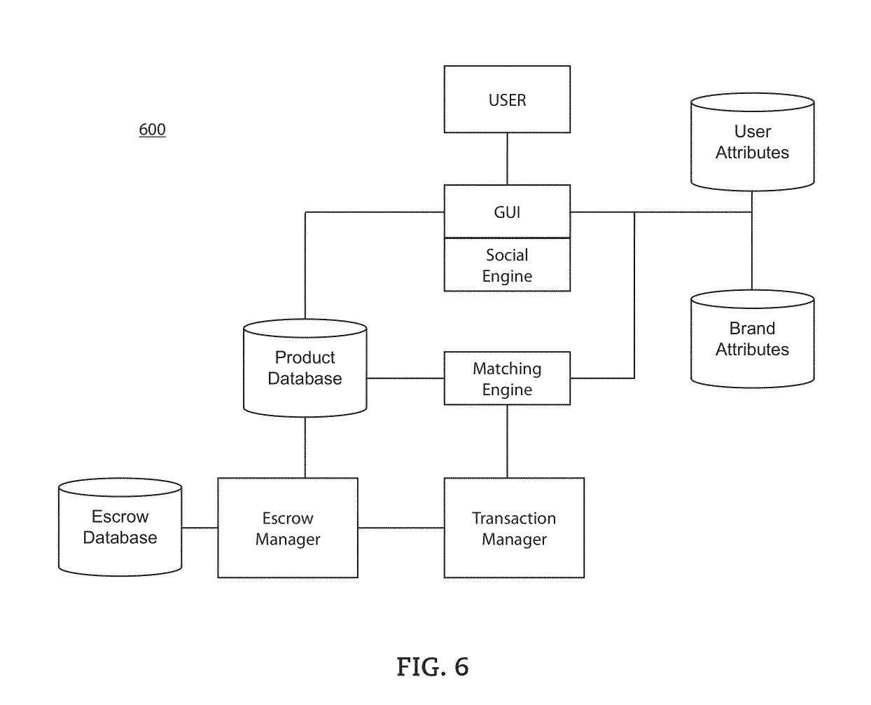

Referring back now to FIG. 6, the matching engine of the present invention may further allow at least two users to be “matched” via the social engine in accordance with at least the user attributes. For example, a first user may be altered by the system that a second user has at least one similar attribute, such as, for example, is approximately the same size, prefers the same designer brands, is interested in the same good(s), and/or has similar interests apart from the goods themselves, such as being fiends and/or shoring a certain political view, for example. In this way, a “style soul mate” may be established which may facilitate and/or enhance the flow of goods through the present invention. For example, two matched users may look to shop the goods offered in the system together, may suggest to one another goods found through the system, and/or may comment or provide an opinion on an offered item, for example. Matched users may also more readily exchange and/or sell goods between them.

Similarly, a “style soul mate” may be provided access to a matched user's on-line inventory of goods, even if such goods are not offered for sale or otherwise available within the system. In this way, a user may be exposed to a variety of suggested goods and the style and choices made by the at least one second user. A user's “closet” or inventory of goods may include text descriptions of goods, stock images, URL links, artist renditions, video, and/or photos. The user may update the virtual closet remotely and may include, for example, images taken of themselves, friends, storefronts, displays and the like which may display at least one goods which may included in the user's virtual closet.

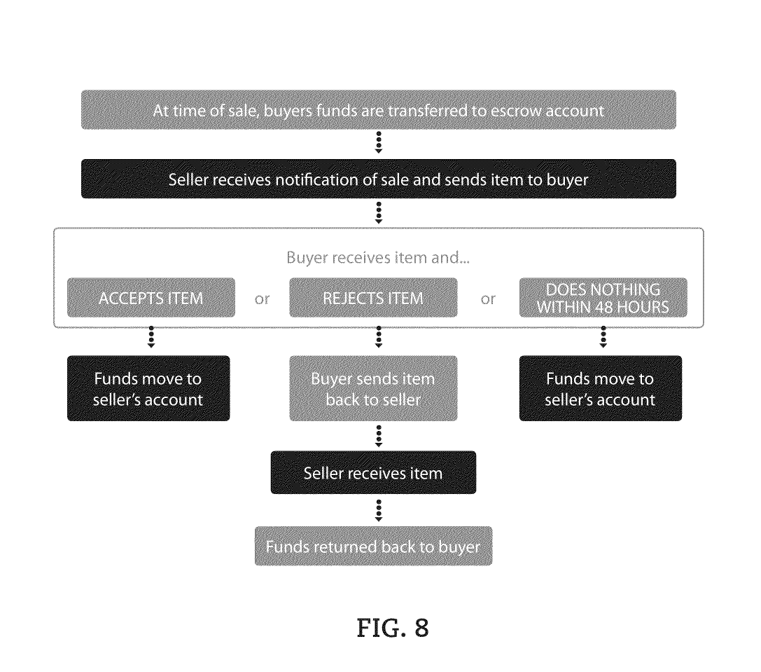

In an embodiment of the present invention, an escrow manager may facilitate the exchange of funds between a buyer and purchaser of goods within the present invention. As further illustrated in FIGS. 6 and 8, the escrow manager may allow funds from a sale to be handled in accordance with the actions of the buyer and ultimate disposition of the goods. For example, at the time a good(s) is sold, funds from a buyer may be transferred by the escrow manager to at least escrow account (not shown) and may record such transaction in the escrow database. The seller of the good(s) may then receive a notification that the good offered for sale was sold and may be provided with other information, including information about the purchasing user, the time the purchase was made, and how many users looked at the item before the sale occurred, for example.

The good(s) may be sent to the purchasing user who may then decide to accept the item or reject the item. If a good(s) is accepted by the purchasing user, the specific funds held in escrow may be transferred to an account accessible by the selling user. If the purchasing user rejects the good(s), for any reason, the good(s) may be returned to the selling user who may in turn release the purchasing user's funds back to the purchasing user one the selling user receives the good(s) in a satisfactory manner. If a transaction occurs and the purchasing user fails to report acceptance or rejection back to the system, the funds provided to the selling user may be transferred to the selling user from escrow after a pre-determined period of time, such as, for example 48 hours.

Of course, as would be appreciated by those skilled in the art, each selling user of the system may pay a fee for use of the system. Such a fee may be a one-time fee, annual fee and/or a fee based on the sale price of a good(s) sold to a second user of the system. For example, the escrow manager may extract a fee equal to ten percent (10%) of the value of a dress sold to a particular user.

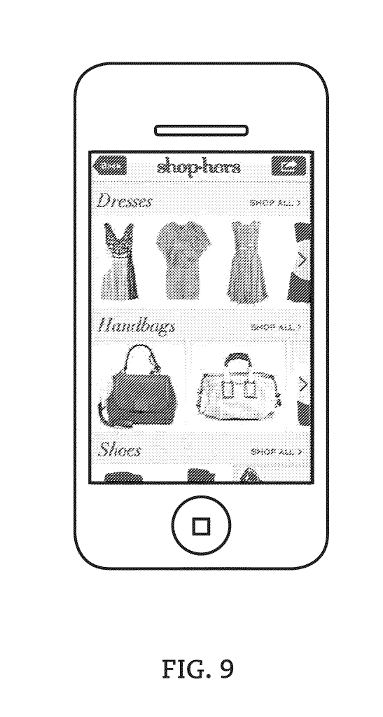

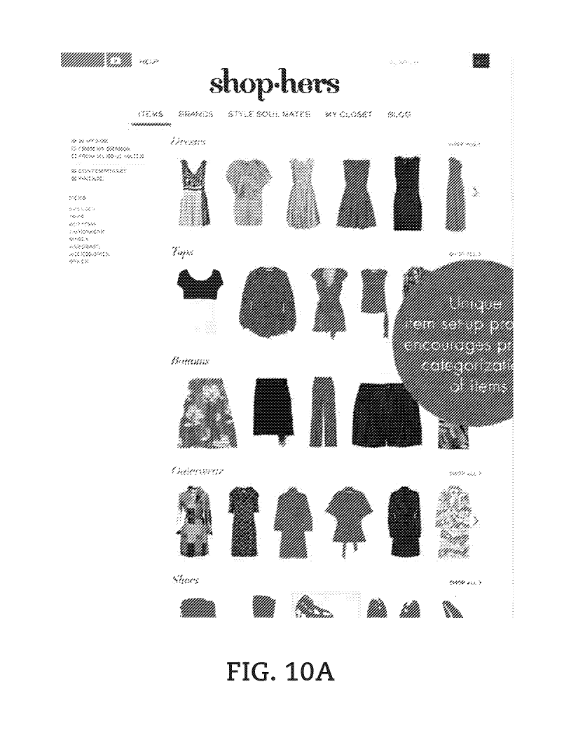

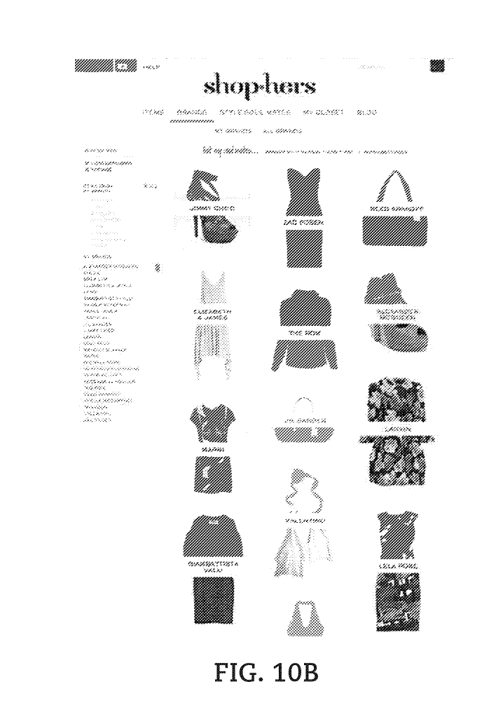

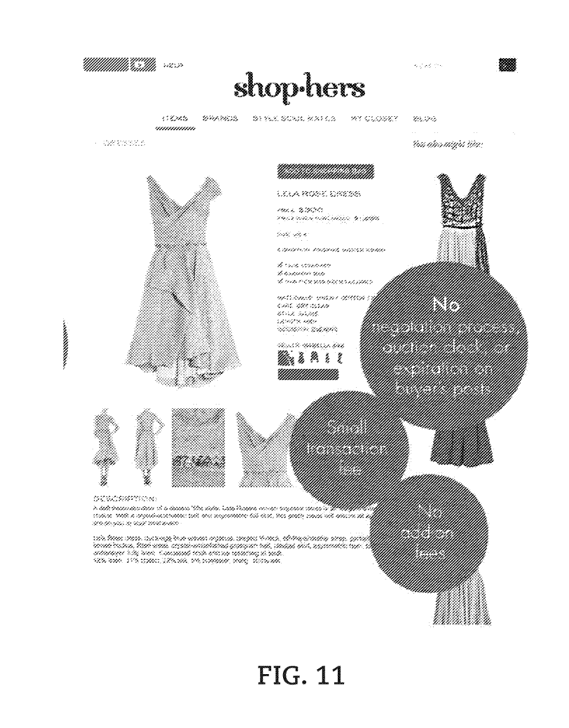

As illustrated in FIGS. 9, 10A and 10B, both a mobile and non-mobile GUI may be provided to a user to allow for the presentation and purchase of goods. For example, a user may search and/or browse available categories of good(s) such as, for example, dress, handbags, and/or shoes. Further information regarding a particular good may be ascertained by selecting the good, such as by selecting the image representing the good, which may in turn provide information to the user which may include attributes of the good, including the price of the good. Such information is further illustrated in FIG. 11 and may include a user provided description of the good(s) and attributes about the goods, including the material(s) of the good, the brand and/or manufacturer, the cleaning care/requirements, style, length (or dimensions), occasion such good(s) is appropriate for, and/or condition (including whether, for example, the good retains its original tags/packaging and/or has been altered from the originally purchased form).

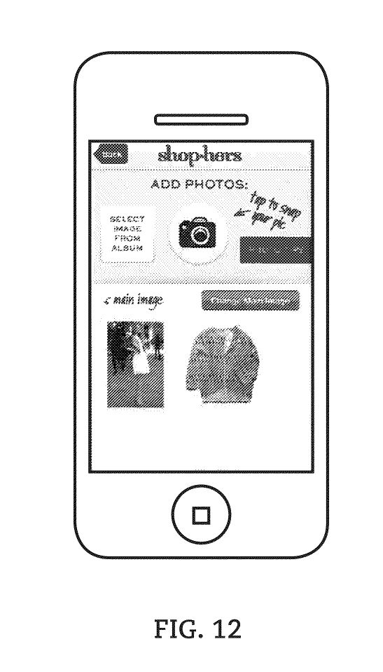

A selling user may, through the mobile GUI of the present invention, for example, as illustrated in FIG. 12, upload images and/or descriptions of good(s) which may be offered for sale to at least one second user. Similar to the non-mobile GUI interface, a user may upload an image to the present invention, either preexisting and/or taken through a camera, for example, may add description and desired attributes, and may then enter the good into the system for sale. The selling user may designate one or more users to whom the good(s) may be presented, may choose from a list of “style soul mates,” and/or may allow the present invention to direct the good to the attention of likely purchasing users as described herein above.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A system for transacting the sale of second-hand items, comprising:
a non-transitory computer readable storage medium having encoded thereon computer executable instructions for providing a graphical user interface capable of locally querying a product database for at least one image and at least attribute of at least one product;
a matching engine for presenting the at least one product to a user of the system in accordance with at least one user attribute and at least one product attribute related to the at least one product; and
a transaction manager for accepting funds from the user in exchange for the at least one product;
wherein the at least one user attribute includes one selected from the group consisting of a user's bust size, waist size, hip size, inseam, and shoe size.

2. The system of claim 1, wherein the at least one product attribute is selected from the group consisting of color, size, brand, designer, location, owner, price, age, and combinations thereof.

3. The system of claim 1, wherein the at least one product is selected from the group consisting of shoes, a dress, pants, a shirt, a blouse, a necklace, a ring, gloves, a scarf, a hat, sunglasses, a belt, socks, hosiery, and combinations thereof.

4. The system of claim 1, wherein the funds are stored in a trust account.

5. The system of claim 1, wherein the at least one user attribute is associated with a size gauge; wherein at least one image of the user and the size gauge is presented to the matching engine.

6. The system of claim 1, wherein the presenting the at least one product is indicative of social media interaction between the user at the seller of the product.
